(19) United States
(12) Patent Application Publication
(10) Pub. No.: US 2025/0088134 A1
(43) Pub. Date: Mar. 13, 2025

(54) SOLAR PANEL MOUNTING SYSTEM

(71) Applicant: Unirac, Inc., Albuquerque, NM (US)

(72) Inventors: Jeffrey Ballard, Albuquerque, NM (US); Tarun Kumar Polanky, Hyderabad (IN); Nikhil Babu, Hyderabad (IN); Sindhu Madhavi Gopalam, Hyderabad (IN); Ronald Gary Norman, Louisville, CO (US)

(21) Appl. No.: 18/827,518

(22) Filed: Sep. 6, 2024

Related U.S. Application Data
(60) Provisional application No. 63/537,300, filed on Sep. 8, 2023.

(51) Int. Cl. H02S 20/20; H02S 40/30

(52) U.S. Cl. CPC H02S 20/20; H02S 40/30

(57) ABSTRACT

A solar panel mounting system includes two base rails each having a south clamp, a north stanchion with a north clamp, and ballast rails connected thereto. The base rails are secured to a structure for the installation of solar panels through one or more roof pads. The ballast rails extend transverse to the base rails. The south clamp and north clamp are engaged to secure solar panels. The system also includes a wire management clip for managing wires of the solar installation.

### RELATED APPLICATIONS

This application claims priority to U.S. Provisional Patent Application No. 63/537,300, filed on Sep. 8, 2023, the entire contents of which are incorporated herein by reference.

### BACKGROUND

As the solar energy industry continues to grow, the equipment to mount photovoltaic (PV) modules (alternatively referred to herein in some instances as “solar panels”) on different types of structures and/or locations continues to adapt and improve as well. The number of parts and/or different arrangements of the parts used to mount the PV modules are in constant change to minimize the amount of time a worker may be working in potentially hazardous conditions and to minimize the cost of both parts and labor.

The PV module is typically used as a component of a larger PV system to generate and supply electricity in commercial and residential applications. A single PV module can only produce a limited amount of power. Thus, most installations contain several PV modules to form a PV array. Some PV arrays are mounted on rooftops, while others are anchored to the ground with each of the PV modules in a fixed position facing generally south.

Moreover, solar photovoltaic power plants are experiencing a continuous increase in capacity every day. Further, the dimensions of solar panels continue to rise. Ensuring the secure and stable installation of these larger solar panel arrays has become crucial.

### BRIEF DESCRIPTION OF THE DRAWINGS

The Detailed Description is set forth with reference to the accompanying figures. In the figures, the left-most digit(s) of a reference number identifies the figure in which the reference number first appears. The use of the same reference numbers in different figures indicates similar or identical items. Furthermore, the drawings may be considered as providing an approximate depiction of the relative sizes of the individual components within individual figures. However, the drawings are not to scale, and the relative sizes of the individual components, both within individual figures and between the different figures, may vary from what is depicted. In particular, some of the figures may depict components as a certain size or shape, while other figures may depict the same components on a larger scale or differently shaped for the sake of clarity.

FIG. 1 illustrates a perspective view of a solar panel mounting system, according to an embodiment.

FIG. 2 illustrates a perspective view of alternative ballast orientation variations of implementation of components of the solar panel mounting system, according to an embodiment.

FIG. 3 illustrates a perspective view of a solar panel mounting system and call-out views of various components associated with the solar panel mounting system, according to an embodiment.

FIG. 4 illustrates a perspective view of a component for use in a solar panel mounting system, according to an embodiment.

FIG. 5 illustrates a perspective view of a component for use in a solar panel mounting system, according to an embodiment.

FIG. 6 illustrates a perspective view of a pair of ballast rails showing a ballast rail brace, according to an embodiment.

FIG. 7 illustrates a perspective view of a ballast rail brace, according to an embodiment.

FIG. 8 illustrates a perspective view of a stanchion and clamp component for use in a solar panel mounting system, according to an embodiment.

FIG. 9 illustrates an exploded views of a detail of a clamp component for use in a solar panel mounting system, according to an embodiment.

FIG. 10 illustrates a detail view of a clamp component for use in a solar panel mounting system, according to an embodiment.

FIG. 11 illustrates a first view of a stanchion and clamp component, according to an embodiment.

FIG. 12 illustrates a perspective view of a stanchion and clamp component, according to an embodiment.

FIG. 13. illustrates a detail view of a clamped solar panel and an unclamped solar panel using components of the solar panel mounting system, according to an embodiment.

FIG. 14 illustrates a view of a clamp component for use in a solar panel mounting system, according to an embodiment.

FIG. 15 illustrates perspective view of a clamp component for use in a solar panel mounting system, according to an embodiment.

FIG. 16 illustrates a perspective view of a rail and clamp component of the solar panel mounting system, according to an embodiment.

FIG. 17 illustrates a perspective view of the clamp component of FIG. 16, according to an embodiment.

FIG. 18 illustrates a view of the clamp component of FIG. 16, according to an embodiment.

FIG. 19 illustrates a perspective view of a rail and wire management clip of the solar panel mounting system, according to an embodiment.

FIG. 20 illustrates a view of a profile of a wire management clip of the solar panel mounting system, according to an embodiment.

FIG. 21 illustrates a view of a profile of a wire management clip of the solar panel mounting system, according to an embodiment.

FIG. 22 illustrates a wind deflector of a solar panel mounting system, according to an embodiment.

FIG. 23 illustrates a corner support bracket for a wind deflector of a solar panel mounting system, according to an embodiment.

FIG. 24 illustrates a perspective view of a solar panel mounting system showing a wind deflector and corner support bracket, according to an embodiment.

FIG. 25 illustrates a perspective view of a wire management cover of the solar panel mounting system, according to an embodiment.

FIG. 26 illustrates a view of a profile of a wire management cover of the solar panel mounting system, according to an embodiment.

FIG. 27 illustrates a perspective view of a wire management cover of the solar panel mounting system, according to an embodiment.

FIG. 28 illustrates a view of a profile of a wire management cover of the solar panel mounting system, according to an embodiment.

FIG. 29 illustrates a profile view of a surface mounting pad for a solar panel mounting system, according to an embodiment.

FIG. 30 illustrates an end view of a surface mounting pad for a solar panel mounting system, according to an embodiment.

FIG. 31 illustrates a view of a portion of a base rail including markings showing spacing for configuring base rail components based on widths of solar panel modules, according to an embodiment.

FIG. 32 illustrates a view of a portion of a base rail including markings showing spacing recommendations and measurements for configuring base rail components based on a width of solar panel modules, according to an embodiment.

FIG. 33 illustrates a view of a portion of a base rail including marking showing locations and indices for guiding assembly of clamp components to the base rail, according to an embodiment.

FIG. 34 illustrates a portion of a north clamp including an upper clamp and a clamping body for securing to a north stanchion, according to an embodiment.

### DETAILED DESCRIPTION

This disclosure is directed to a multi-rail, grid-based PV racking system. The multi-rail, grid-based PV racking system includes a mounting system for solar modules that may be expanded with additional modules based on the size of an installation. In the following description terms “north,” “south,” “east,” and “west” are sometimes used to refer to an orientation with respect to a solar panel module to position the solar panel module for ideal sunlight exposure. The terms “north,” “south,” “east,” and “west” may be used for each solar panel module (e.g., a north side as viewed from above with an east side to the right of the north side as viewed from above, a south side opposite the north side, and a west side to the left of the north side as viewed from above) and may also be used to refer to components of a solar installation array, a row of components, or multiple modules. Although a particular orientation may be described, other orientations and/or positions of the components referred to with the description terms are envisioned. Being multi-rail may indicate that, in a base configuration, each north-south column of modules may be supported by a structure consisting of at least two continuous rails running the length of the column. In an embodiment, such as a high-load situation resulting from weight of modules and/or wind loading or other forces, a north-south column of solar modules may be supported by a structure that includes three or more continuous rails running along a length of the column. Rails may be positioned at locations recommended by module manufacturers or quarter points of the modules. The grid-based nature of the system of this disclosure provides a benefit of load sharing between modules by creating a continuous grid structure of rails running in both the east-west and north-south directions. The load sharing between modules is accomplished by the grid-based system by spreading loads to rails and ballasts of adjacent modules due to the stiffness of the components of the mounting system components. The grid-based nature of the system may also increase speed of installation because the north-south and east-west rails provide a natural layout and alignment of the system that eliminates the need/significantly reduces the need for measurement devices to pre-define and pre-mark on the roof the location and alignment of components of the system on the rooftop. By positioning the north-south rails at the module manufacturers recommended locations (approximately quarter points) along the long side of the module, the system is positioned well to support large format modules.

In an embodiment, the rail may be secured or ballasted to a surface, such as a roof, on which the solar panel modules are disposed. For example, the rail may be fastened (e.g., via screws, brackets, etc.) into the surface. Any number of rails may be disposed on the surface, and any number of solar panel modules may be disposed across the rails. In an embodiment, the solar panel modules may be supported, anchored, secured, etc. to at least two of the rails. For example, the solar panel modules may be supported along one side by a first rail and may be supported along a second side, opposite the first side, by a second rail. In some embodiments, each panel may be supported by more than two rails. In an embodiment, the solar panel modules may be supported at locations recommended by module manufacturers including locations inboard of the sides of the solar panel modules, such as at locations approximately twenty-five percent and approximately seventy-five percent along a length of the solar panel modules, known as quarter points, or proximate to, corners of the solar panel modules.

The rails of the base rail system, which may include base rails that make up a base rail assembly, may be marked with recommended locations indicating distances for overlapping the base rails to form the base rail assembly based on module width and inter-module row spacing. The markings may also include indications of which components connect at which locations of the base rails. As one example, the inter-module row spacing options may range from 10″ to 18″ such as 10″, 13″, and 17″ row spacing options.

The base rails may include rail components such as north, mid, and south rail components that combine to form a single base rail length. The base rails may have profiles that are configured to overlap to maintain continuity of strength and to streamline connection of north, mid, and south rails to form a length of rail. Moreover, adjustable overlap along the length of the rail components may accommodate different module widths for particular installations. The base rails may include flanges that provide strength and rigidity against flexing and/or bending to support the solar panels and installation structures. In an embodiment, the base rails may also include markings to facilitate adjustably varying the length of rail assemblies to correspond to module width measurements and markings to identify hole locations for components to be connected thereto.

In an embodiment, the solar panel mounting system includes clamps that secure the solar modules through a bolted clamp connection with a torqueable and inspectable connection. The clamps being inspectable refers to a bolted connection of the clamp being visible and accessible after installation. The clamps may be adjustable to secure solar modules of varying thicknesses. The clamps include first clamps at a first side of the solar modules, the first clamps including a top component and a bottom component. The top component is connected to a bottom component through a bolted connection and the top component is configured to move relative to the bottom component to tighten around an edge of the solar module. The clamps also include second clamps at a second side of the solar modules. The second clamps may include a clamping body that secures to the solar module at a second height less than a height of the first clamp. The clamps, positioned on vertical supports, position the solar modules at an angle when installed on the structure.

In an embodiment, the clamps may include a “south clamp,” where south is understood in the industry to represent an orientation along a solar panel module to position the solar panel module for ideal sunlight. For example, a first clamp may be disposed on a north side of the solar panel module and a second clamp may be disposed on the south side of the solar panel module. The first clamp may, in some instances, be referred to as a “north clamp,” and the second clamp may, in some instances, be referred to as a “south clamp.” The north-south direction may refer to an orientation of the solar panel. In the northern hemisphere, solar panels generate the most power when they face south (e.g., a face of the solar panel module is oriented towards the southern sky). Additional, mounts, clamps, brackets, etc. may be disposed on a north side of the solar panel module, where such mounts, clamps, brackets, etc. may be considered a “north mount,” “north clamp,” and so forth. However, although a particular orientation is described, other orientations and/or positions of the clamp are envisioned.

The first clamps are positioned on stanchions, a first stanchion such as a “north stanchion,” supports the “north clamp” as described herein. A second clamp may couple to the base rail without a stanchion as described herein. The bases of the clamps or stanchions provide interfaces for securing to the base rails in a secure manner that provides a large landing length with space for secure placement of the solar panels on the structure.

The clamps, including the first clamp and the second clamp, provide connections to the base rails as well as to the solar panels. The connection of the first clamp to the base rail may be accomplished through a base of the vertical supports that hooks or connects to the base rail with a channel and secures into position with a single bolt connection. The clamp connection to the solar panel through the first clamp and/or the second clamp secures through the use of a single bolt between a top and bottom component of the clamps.

The second clamp may, in an embodiment, connect to the base rails through a pin connection that allows the solar panels to be installed vertically into the second clamp before pivoting down and securing an opposite edge of the solar panel with the first clamp. This pivoting connection provides for access to the system for maintenance and wiring without having to fully remove the solar panels, providing an advantage over other solar racking systems.

The clamps and/or stanchions may provide for connecting a modular electronics unit that may include modular electronics for the solar panels as well as a wind deflector and/or trim components. The wind deflector may include a metal sheet rail that connects to the clamp and/or solar panel. The wind deflector may be supported along the length of the wind deflector by connections to the clamps and/or stanchions and also to a corner support bracket that may support an end or corner of the wind deflector. The corner support bracket may connect between the wind deflector and the solar panel frame.

In the solar panel mounting system, ballast blocks rest upon the ballast rails with the ballast blocks in a portrait and/or landscape manner relative to the base rails, providing flexibility in ballast block quantity to resist load demands on the system due to various environmental load demands corresponding to site installations. The ballast rails may be secured perpendicular to the base rails and may also include a ballast rail brace that extends between parallel ballast rails and provides additional rigidity to support the ballast rails and allow the ballast rails to meet the required strength with the least material or lowest cost. The ballast rails may be positioned to fill a vertical gap between the wind deflector and a top of the base rails, thereby reducing the amount of material required for the wind deflector to block horizontal wind flow across the structure.

The base rails may rest on or contact the structure through roof pads that distribute a load over the structure and installation on the roof, protects the roof membrane from metal edges of the mounting system, and provides friction to prevent the mounting system from sliding. The roof pads may be stackable to accommodate height adjustments for uneven roof surfaces.

The solar mounting system may include wire management components that enable a tool-less, snap fit connection for wire management clamps to retain wires used for installations of the solar panels. The wire management components may include clamp components that snap onto a profile of the base rail, ballast rail, or other components of the solar panel mounting system. The wire management components may include a wire management clip that defines a channel that is at least partially enclosed. The wire management clamps may include flanges that snap together in an embodiment to provide an enclosed perimeter to capture the wires for the solar panel installation.

In an illustrative embodiment, the systems described herein provides a solar panel mounting system. The solar panel mounting system includes a base rail and a roof pad formed of an elastomeric material that rests between the base rail and a structure. The system may also include a north stanchion including a first vertical support connected at a first end to the base rail and having a first height and a first clamp at a second end of the first vertical support the first clamp configured to secure an edge of a solar panel. The system may also include a south clamp including a second vertical support connected at a first end to the base rail and having a second height less than the first height and a second clamp at a second end of the second vertical support, the second clamp configured to secure an edge of the solar panel. The system may also include a ballast rail arranged perpendicularly to and connected with the base rail, the ballast rail configured to support one or more ballasts within the ballast rails.

In an illustrative embodiment, the solar panel mounting system may include a wind deflector including a metal panel securable to the north stanchion and optionally a corner backet configured to connect between the edge of the solar panel and the wind deflector. The south clamp may include a pivotal connection between the first vertical support and the one of the first base rail or the second base rail, and the second clamp includes a mount including a base defining a slot and a channel, a first flange extending from the base, and a second flange extending from the base and a connector including a keeper that transitions between a first position in which the solar panel is insertable onto the mount, and a second position in which the solar panel is clamped to the mount, the connector including a pin disposed at least partially through the channel, and a fastener disposed at least partially through the slot to attach the connector to the mount. The roof pad includes a rectangular body and one or more protrusions extending from an upper surface of the rectangular body, the one or more protrusions configured to fit within one or more openings of the base rail. The solar panel mounting system may include a first ballast rail arranged parallel to a second ballast rail and a ballast rail support including a metal component having a first clip that connects with the first ballast rail and a second clip that connects with the second ballast rail. The base rail may include an angled end forming the second vertical support. The solar panel mounting system may include a wire management clip including: a rail connection component configured to connect with the base rail and a wire clamp may include a channel and a tab configured to enclose a passage for receiving one or more wires of a solar panel installation.

In an illustrative embodiment, the second clamp may include a bottom component including a first support surface and a first plurality of horizontal protrusions arranged on a vertical portion of the bottom component and a top component including a second support surface and a second plurality of horizontal protrusions arranged on a vertical portion of the top component, the second plurality of horizontal protrusions and first plurality of horizontal protrusions configured to interface together to adjust a vertical position of the top component relative to the bottom component with a threaded connector through the top component and into the bottom component. The first vertical support of the bottom component may include a first plurality of horizontal protrusions and the second clamp includes a horizontal portion extending from the first vertical support of the bottom component and an upper portion including a second plurality of horizontal protrusions, the upper portion positionable with respect to the first vertical support of the bottom component.

In an illustrative embodiment, one general aspect includes a modular system for mounting one or more panels to a structure. The modular system includes two or more base rails arranged in parallel with one another. The modular system may also include one or more roof pads that rest against the base rails. The system also includes one or more south clamps, where a south clamp of the one or more south clamps includes a first vertical support connected to one of the base rails and has a first height and clamps to an edge of a solar panel. The system also includes one or more north stanchions, where a north stanchion of the one or more north stanchions includes a vertical support connected to one of the base rails and has a second height, the first height greater than the second height and also includes a north clamp at an end of the vertical support, the north clamp configured to secure an edge of the solar panel. The system may also include a ballast rail arranged perpendicularly to and connected between the first base rail and the second base rail, the ballast rail configured to support one or more ballasts connected to the solar panel.

In an embodiment, the components of the mounting system may be formed from any suitable materials, such as metals, composites, plastic, etc. In an embodiment, the mount may be formed from a piece of metal (e.g., steel, aluminum, etc.) that is stamped, bent, etc. to form the base, first flange, second flange, lip, etc. Post-processing techniques, for example, drilling may form through holes, channels, slots, etc. In an embodiment, the connector may be formed via extrusion, injection molding, die casting, etc. Post-processing techniques, for example, milling may form the lip, holes for the pins, and so forth.

The present disclosure provides an overall understanding of the principles of the structure, function, device, and system disclosed herein. One or more examples of the present disclosure are illustrated in the accompanying drawings. Those of ordinary skill in the art will understand that the devices and/or the systems specifically described herein and illustrated in the accompanying drawings are non-limiting embodiments. The features illustrated or described in connection with one embodiment may be combined with the features of other embodiments. Such modifications and variations are intended to be included within the scope of the appended claims.

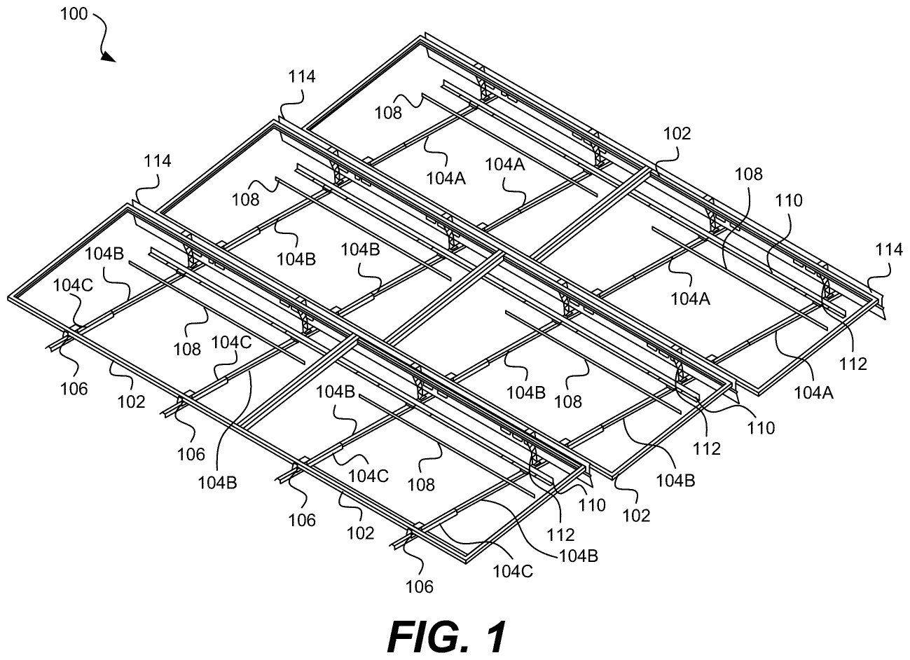

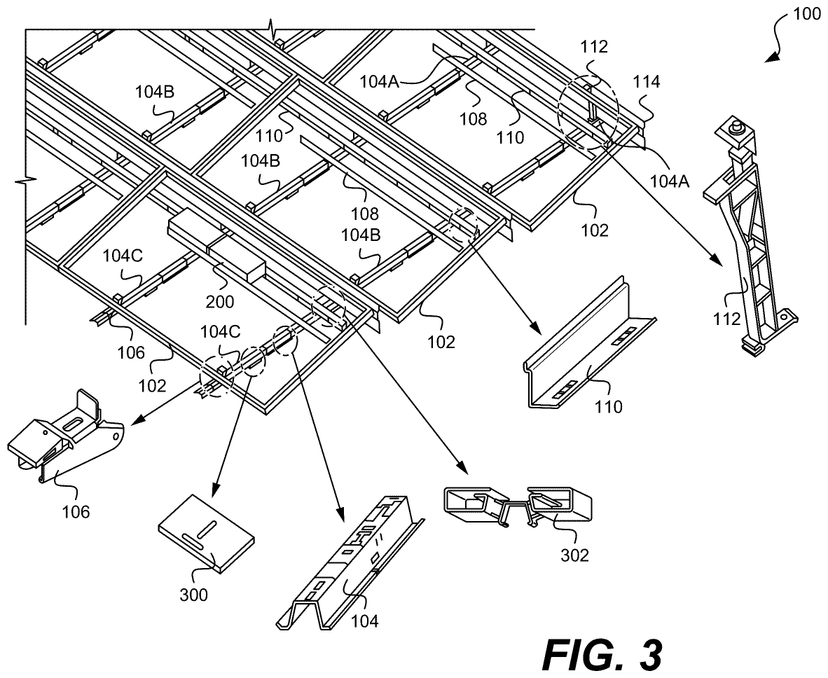

FIGS. 1-3 illustrates perspective views of a solar panel mounting system 100, according to an embodiment. The solar panel mounting system 100 may be a modular solar panel mounting system 100 that includes a multi-rail, grid-based solar panel mounting system. The solar panel mounting system 100 is used for mounting solar panels 102 (shown with frames only with glass/panels removed). The mounting system includes north rails 104A, mid rails 104B and south rails 104C (collectively referred to as base rails 104) supporting modules (with two columns and 3 rows of modules shown in FIG. 1). The south rails 104C may terminate on a south side of the array of solar panels with enough length to enable a ballast tray to be placed on the south side of the array. The ballas being placed on a south side of a solar array is beneficial to provide enhanced load resistance, for example against high wind loading. The south rails 104C may be shorter than a mid rail 104B such that the south rail does not extend are form a potential obstruction or protrusion from underneath the solar panels. The base rails 104 may indicate a direction of the mounting system, according to an industry convention, the base rails 104 may be arranged a north-south column.

The base rails 104 may run a length of the north-south column and may be continuous rails. The base rails 104 may be formed of segments of rail or may be a single base rail. In an embodiment, the base rails 104 may be positioned at quarter-points along the lengths of the solar panels 102. The quarter-points may be positioned one-quarter and three-quarters of the way along the length of the solar panels 102. In an embodiment, the base rails 104 may be positioned at other spacing or intervals to support the solar panels 102. At an end, the solar panels 102 are secured to the base rails with a south clamp 106.

In an embodiment, the base rails 104 may be secured to a surface, such as a roof, on which the solar panels 102 are disposed. For example, the base rails 104 may be fastened (e.g., via screws, brackets, custom attachment assemblies designed for the system etc.) into the surface. Any number of base rails 104 may be disposed on the surface, and any number of solar panels 102 may be disposed across the base rails 104. In an embodiment, the solar panels 102 may be supported, anchored, secured, etc. to two of the base rails 104. For example, the solar panel modules may each be supported by two or more base rails 104 In an embodiment, the solar panels 102 may be supported at locations recommended by module manufacturers including locations inboard of the sides of the solar panels 102, such as at locations approximately twenty-five percent and approximately seventy-five percent along a length of the solar panels 102, known as quarter points, or proximate to, corners of the solar panels 102.

The base rails 104 may be marked with recommended clamping locations based on recommended and row spacing, as shown and described with respect to FIGS. 31-33. For example, the spacing options may range from 10″ to 18″. For example, in an embodiment the spacing may also or alternatively include 10″, 13″, and 17″ row spacing options. The solar panel mounting system 100 may, in an embodiment, enable installations at or exceeding a module footprint of 100″×52″ that may be multiplied or modularly installed adjacent to one another. In an embodiment, the various rails and clamps may be assembled prior to being placed on the roof with the solar panels 102 installed after installation of the solar panel mounting system 100.

The base rails 104 may include rail components such as north rail 104A, mid rail 104B, and south rail 104C components that combine to form a single base rail length. The base rails 104 may have profiles that are configured to overlap to streamline connection of north, mid, and south rails to form a length of rail. Moreover, an adjustable overlap along the length of the rail components may accommodate different module widths for particular installations. The base rails 104 may include flanges that provide strength and rigidity against flexing and/or bending to support the solar panels and installation structures.

Between the base rails 104 there are ballast rails 108 and ballast rails 110. The base rails 104 provide load sharing in a north-south direction and the ballast rails 108 and 110 provide load sharing in an east-west direction between adjacent modules by creating a continuous grid structure of rails running in both the east-west and north-south directions. The ballast rails 108 may include south ballast rails that terminate on at or about an edge of the solar panel module, the ballast rails 110 may include north ballast rails that may extend across a row of solar panel modules. As depicted, the ballast rails 108 may extend between two base rails 104 and the ballast rails 110 may extend across base rails 104 for multiple modules. This grid-based arrangement of the base rails 104 and the ballast rails 108 and 110 may also increase a speed of installation because the north-south and east-west rails provide for a natural layout and alignment of the solar panel mounting system 100 that eliminates the need and/or significantly reduces the need to pre-layout the entire system position on the roof surface or other structure (measurement devices to locate, align and mark the position of components of the system). By positioning the base rails 104 at the quarter points of the solar panels 102, the solar panel mounting system 100 is positioned to support large format solar panels 102 by clamping at manufacturer's recommended locations.

The solar panels 102 are secured to the base rails 104 through the south clamp 106 at one edge and through a north clamp 112 at an edge. The south clamp 106 and the north clamp 112 may position the solar panels 102 at an angle for the particular installation.

The solar panel mounting system 100 includes a wind deflector 114 that connects to the north stanchion assemblies 112 and/or the solar panel 102. The wind deflector 114 runs along a north edge of the solar panels 102 and deflects wind from traveling under the solar panels 102 and/or applying an upwards force on the solar panels 102. The wind deflector 114 also acts as a trim component that partially encloses and obscures the solar panel mounting system 100 when installed on a roof or other structure.

In an embodiment, the clamps may include a “south clamp,” where south is understood in the industry to represent an orientation along a solar panel module to position the solar panel module for ideal sunlight. For example, the second clamp may be disposed on the south side of the solar panel module. The first clamp may include a “north clamp,” where north is understood to represent an orientation along a solar panel module. Additional, mounts, clamps, brackets, etc. may be disposed on a north side of the solar panel module, where such mounts, clamps, brackets, etc. may be considered a “north mount,” “north clamp,” and so forth. However, although a particular orientation is described, other orientations and/or positions of the clamp are envisioned.

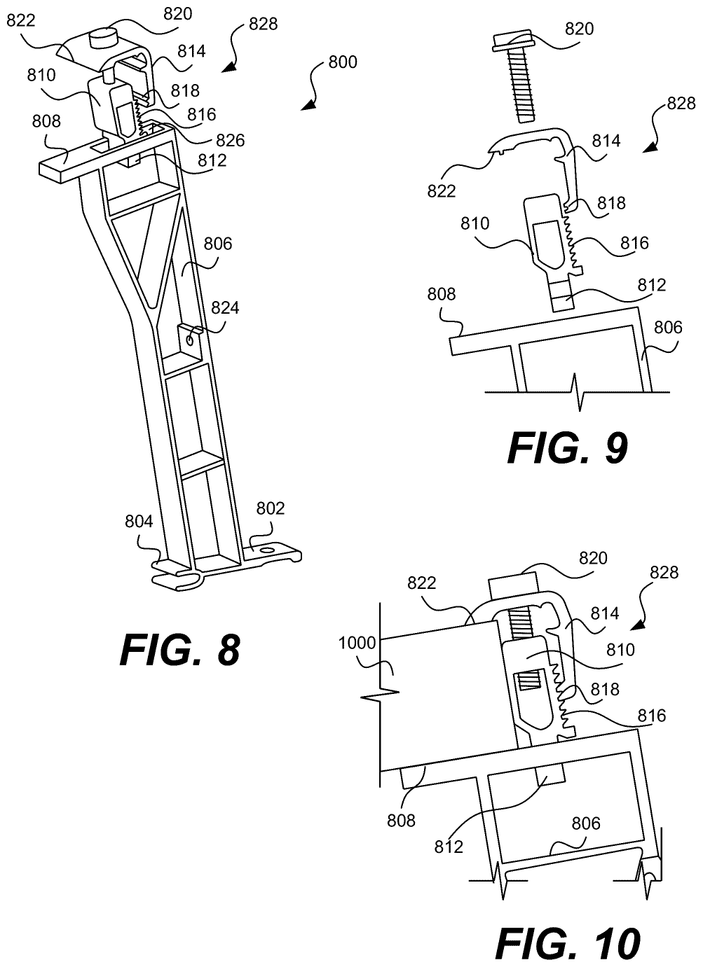

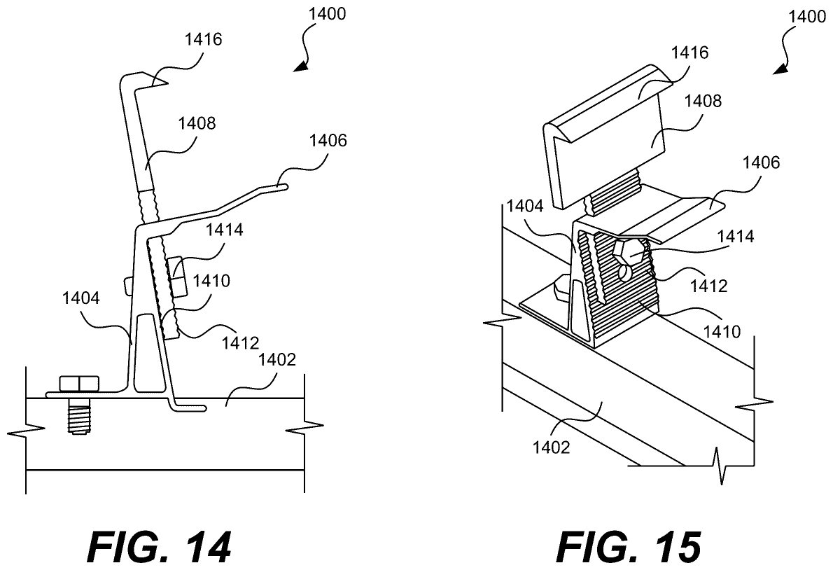

In an embodiment, the solar panel mounting system 100 includes a south clamp 106 and a north clamp 112 that secures the solar panels 102 through a clamp connection with a torqueable and inspectable connection. The clamps may be adjustable to tighten around solar panels 102 of varying thicknesses. The details of embodiments of the south clamp 106 are shown and described with respect to FIGS. 14-18. The details of embodiments of the north clamp 112 are shown and described in further details with respect to FIGS. 8-13. The clamps, positioned on vertical supports, position the solar panels 102 at an angle when installed on the structure.

In an embodiment, the clamps may be positioned on stanchions, a first stanchion such as a “north stanchion,” supports the “north clamp” as described herein and is used to support an edge of the solar panel. A second clamp such as a “south clamp” as described herein is used to support an opposite edge of the solar panel to orient the solar panel towards a southern sky. The bases of the clamps provide interfaces for securing to the base rails in a secure manner that provides a large landing length with space for secure placement of the solar panels on the structure.

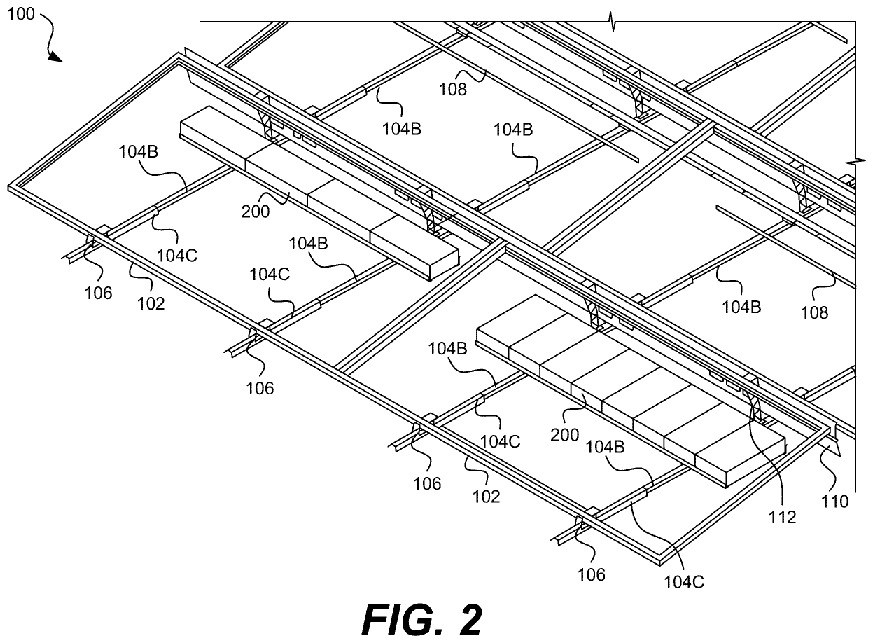

In FIG. 1, the ballast rails 108 and 110 are shown without any ballast 200 (ballast shown in FIG. 2) placed thereon within the solar panel mounting system 100. In an embodiment, the ballast rails 108 and 110 are reconfigurable so that the ballast 200 may be oriented in more than one orientation, such as for example, portrait or landscape orientation with respect to the base rails 104 (and likewise other elements of the solar panel mounting system 100). For example, the reorientation of the ballast 200 may be accomplished via repositioning at least one of ballast rails 108 and 110, along the base rails 104.

In the solar panel mounting system 100, ballasts 200 may be secured to the base rails 104 through ballast rails 108 and 110 in a portrait and/or landscape manner relative to the base rails 104, providing amenability to desired situations and requirements of various installations. The ballast rails may be secured perpendicular to the base rails and may also include a ballast rail brace that extends between parallel ballast rails and provides additional rigidity to support the ballast rails. The ballast rails may be positioned to fill a vertical gap between the wind deflector and a top of the base rails, thereby reducing the amount of material required for the wind deflector to block horizontal wind flow across the structure.

Notably, in order to assist in providing a better view of the mounting components, the solar panels 102, which may be provided by a separate supplier to be mounted on/with the solar panel mounting system 100, are depicted in FIGS. 1-3 essentially as a frame, with the glass removed. In an embodiment, the base rail 104 may be formed in two (or more) adjoinable pieces including a south portion onto which a south clamp attaches, and a north portion onto which the north clamp 112 attaches. Further, as indicated, a third adjoinable piece of a mid-portion may be useful to further adjust for varying module widths.

The base rails 104 may connect to the structure through roof pads 300 that distribute a load of the solar panel mounting system 100 on the roof, protects the roof membrane from metal edges of the solar panel mounting system 100, and provides friction to prevent the solar panel mounting system 100 from sliding. The roof pads 300 may be stackable to accommodate height adjustments for uneven roof surfaces.

The solar panel mounting system 100 may include wire management components 302 that enable a tool-less, snap fit connection for retaining wires used for installations of the solar panels 102 and ballasts 200. The wire management components 302 may include clamp components that snap onto a profile of the base rail 104, ballast rail 108 or 110, or other components of the solar panel mounting system 100. The wire management components 302 may include a wire management clip that defines a channel that is at least partially enclosed. The wire management components 302 may include flanges that snap together in an embodiment to provide an enclosed perimeter to capture the wires for the solar panel installation.

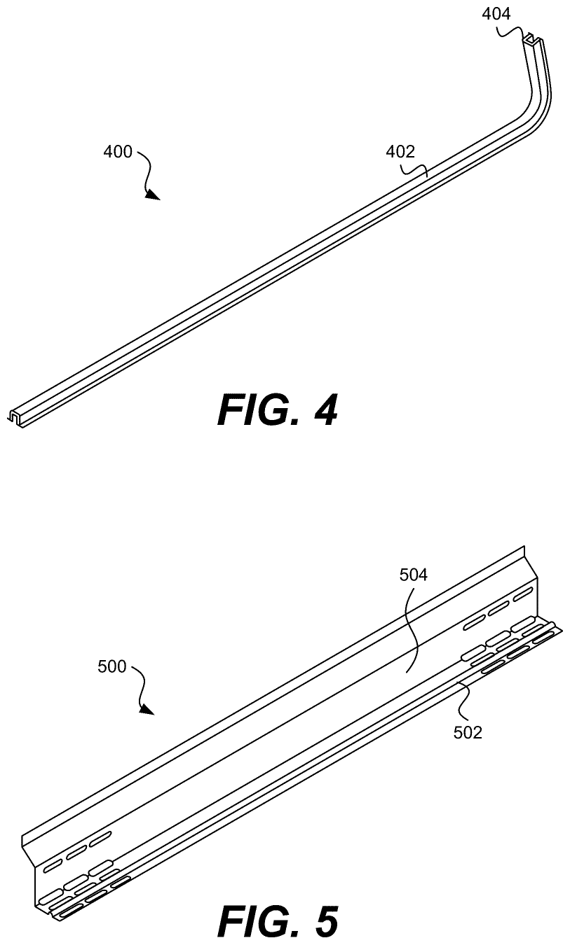

FIG. 4 illustrates a perspective view of a base rail 400 for use in a solar panel mounting system 100, according to an embodiment. The base rail 400 is shown with a horizontal portion 402 that may have a partially U-channeled profile for strength, to reduce risk of bending/twisting/collapsing under the load of the other portions of the solar panel mounting system 100, as well as other solar electrical equipment. The base rail 400 may further include various slots, holes, divots, indents, etc. to assist in connecting and securing the mounting equipment thereto. The base rail 400 is also shown with a portion 404 that may include an up-turned or bent portion 404 of the base rail 400. In an embodiment, the bent portion 404 of the base rail 400 may form a portion of a vertical support for a clamp to secure a solar panel 102. In an embodiment, the base rail 400 may only include the horizontal portion 402, such as shown in FIGS. 1-3.

Additionally, and/or alternatively, other features of the disclosure, as shown in FIG. 4, may include an embodiment of a bent base rail to combine the function of the base rail and the “north stanchion” support into a single component base rail/support. The base rail 400 and/or base rail 104 may have a u-channeled profile for strength, to reduce risk of bending/flexing, and may include a first linear portion connected to a bent portion that runs continuously into a shorter upwardly extending second linear portion.

FIG. 5 illustrates a perspective view of a ballast rail 500 for use in a solar panel mounting system, according to an embodiment. As shown in FIGS. 1-3, the ballast rail 500 may be positioned along the base rail 104 extending transversely thereto, continuously, or in alternative embodiments (not shown) non-continuously, according to the desired setup. The ballast rail 500 may have an L-shaped or similarly shaped profile via which a corner or edge of the ballast 200 may rest. A pair of ballast rails 500 may be used to support the ballast 200, with opposite corners or edges of the ballast resting thereon. A horizontal portion 502 of the ballast rail 500 may support the weight of the ballast 200 and a vertical portion 504 of the ballast rail 500 may prevent the ballast from shifting transversely across the ballast rail 500. Additionally, holes or openings or obstructions formed in the end of the ballast rail 500 may be used to prevent the ballast 200 from sliding laterally out of the end of the ballast rails/tray, for example holes filled with threaded connectors. The holes or openings may also be used to secure the ballast rails 500 to the base rails 104.

In an embodiment, the ballast rail 500 may include the vertical portion 504 to serve as a combination of a wind deflector and ballast support or may from the lower portion of a wind deflector system with a separate wind deflector forming the upper portion of the wind deflector system. For example, ballast rails 500 may be supported on one or more base rails 104 with the ballast rail 500 serving as a retention system for the ballast 200.

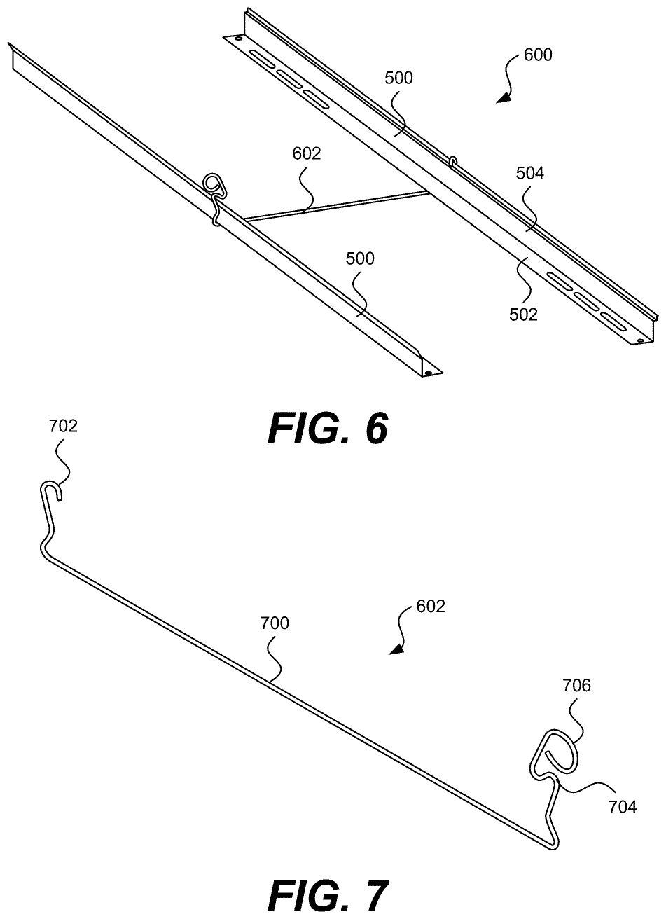

FIG. 6 illustrates a perspective view of a ballast tray including a pair of ballast rails 500 and a ballast rail brace 602, according to an embodiment. The ballast tray 600 includes a first ballast rail and a second ballast rail oriented such that the horizontal portion 502 of the ballast rails 500 face each other and form a support or brace for supporting and containing the ballast 200. The ballast tray 600 also includes a ballast rail brace 602, as shown in FIG. 7.

Optional ballast rail brace 602 includes a crossmember 700 that spans a distance between the ballast rails 500 of a ballast rail system 600. The ballast rail brace 602 provides support and additional structural rigidity to the ballast rails 500. In an embodiment, the ballast rail brace 602 may prevent the ballast rails 500 from bending outwards, thereby ensuring that the ballast 200 remains situated between and secured within the ballast rails 500. Additionally, the ballast rail brace 602 may prevent twisting of the ballast rails 500 when loaded.

The ballast rail brace 602 includes the crossmember 700 and at a first end of the crossmember 700 a first clip 702 that is bent to wrap around an outer perimeter of the ballast rail 500 and hooks onto an upper edge of the ballast rail 500 with the first clip 702. The ballast rail brace 602 also includes a second clip 704 at an opposite end of the crossmember 700 from the first clip 702. The second clip 704 may have a similar shape and/or function to the first clip 702. The ballast rail brace 602 also includes an interface 706 connected to the second clip 704. The interface 706 is connected to an end of the second clip 704 such that a force applied to the interface may bend or temporarily deform the second clip 704 to enable installation onto the ballast rail 500.

FIGS. 8-10 illustrate a stanchion and clamp assembly 828 for use in a solar panel mounting system 100, according to an embodiment. For instance, FIG. 8 includes a perspective view of the north stanchion 800. FIG. 9 includes an exploded view of a clamp assembly 828 of the north stanchion 800. FIG. 10 includes a detailed view of the clamp component of the north stanchion 800 with an edge of a solar panel 1000 secured therein. A structure 806 and clamp assembly 828 may form a north stanchion 800 for connecting at a first end to the base rail 104 and at a second portion to an edge of a solar panel 102.

In an embodiment, the north stanchion 800 may include a base 802, channel 804, structure 806, and clamp assembly 828. The base 802 extends from the bottom of the structure 806 and includes a passage for a threaded connector to secure to the base rail 104. The channel 804 may likewise be used to locate and secure the north stanchion 800 to the base rail 104. The structure 806 includes a framework structure with strutted supports extending between opposing elongated outer frame bars. The north stanchion 800 may be oriented when installed such that a longer dimension thereof extends upwardly from the base rail 104 and extends to a height greater than a height of a south clamp. When installed, the north stanchion 800 is positioned such that the height difference provides a desirable south to north increasing slope for optimum sun exposure of the solar panels 102.

Moreover, the lower end of the structure 806 may be secured to the base rail 104 (on the north end of the solar panel 102) via one or both of a fastener (not shown) or a toothed channel 804 configured to slide into a slot in the base rail 104. Further, the clamp assembly 828 may include a pin to form a bonded connection to the solar panel 102. The clamp assembly 828 of the north stanchion 800 is configured to clamp the solar panels 102.

The clamp assembly 828 includes a support ledge 808, a clamp body 810, a stanchion connector 812, an upper clamp 814, first protrusions 816, second protrusions 818, threaded connector 820, and clamp surface 822. The support ledge 808 is connected to an upper end, such as a distal end of the structure 806. The support ledge 808 may support an edge of a frame of a solar panel 1000, as depicted in FIG. 10. The clamp body 810 connects to the support ledge 808 and/or structure 806 and provides for adjustment of the upper clamp 814 relative to the clamp body 810 to adjust a distance between the support ledge 808 and the clamp surface 822. The adjustment of the upper clamp 814 relative to the clamp body 810 may be accomplished by positioning the first protrusions 816 interlocking with the second protrusions at a desired height. The threaded connector 820 extends through the upper clamp 814 to secure the upper clamp to the clamp body 810 at the desired height.

The stanchion connector 812 may be keyed (e.g., may include slots/indentations/divots, or other features that are positioned along a lower end of the body of the stanchion connector 812) to be inserted into a slotted aperture 826 in a top end (a frame wall) of the structure 806, and then rotated to a secure, slidable position within the slotted aperture 826. As such, the keyed portion of the stanchion connector 812 aligns with the structure of the slotted aperture 826 through the end of the structure 806. In such a position, a first side of the stanchion connector 812 may serve as an edge brace for the solar panel 1000, while the clamp surface 822 provides a lower clamping surface for the solar panel 1000.

On a second, opposite side of the stanchion connector 812 a structural engagement feature including the first protrusions 816, such as for example, elongated teeth, may be located to engage with the upper clamp 814, which includes a corresponding structural engagement feature including the second protrusions 818, such as for example, one or more oppositely angled elongated teeth, to engage with the stanchion connector 812 to permit size adjustments for varying thicknesses of different solar panels 1000. Thusly, a bottom-facing surface of the upper clamp 814, including the clamp surface 822 may serve as an upper clamping surface to clamp against the upper surface of the frame of the solar panel 1000. Additionally, the clamp assembly may include a connector 820, such as a threaded bolt, to secure the upper clamp 814 to the stanchion connector 812, which is secured to the structure 806.

In an embodiment, the north stanchion 800 may also provide a position 824 on one of the opposing elongated frame bars of the structure 806 at which a wind deflector may attach with a threaded connector.

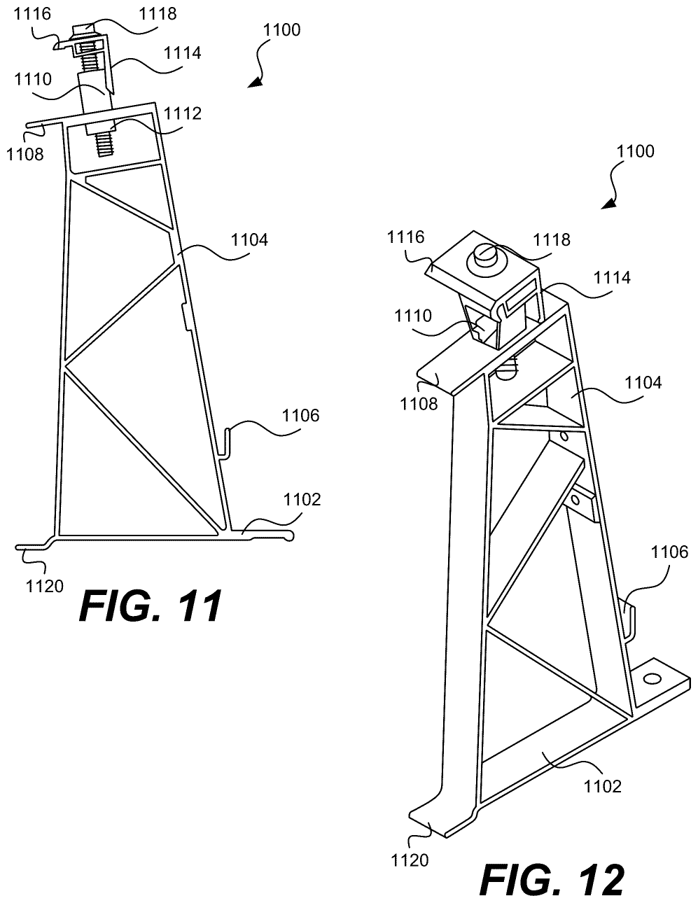

FIGS. 11-12 illustrate a stanchion and clamp component, according to an embodiment. The stanchion may be an example of a north stanchion that is used to secure the solar panel 102 to the base rail 104. As depicted in FIGS. 11-12, the stanchion 1100 includes a base 1102, which may be similar or identical to the base 802. The base 1102 is depicted with an extended length, as compared with the base 802 and includes a tab 1120 that inserts into a rail, such as the base rail 104. The tab 1120 inserts into an opening of the base rail 104 and rests below an upper surface of the base rail.

The stanchion 1100 includes a structure 1104 that includes a framework structure with strutted supports extending between opposing elongated outer frame bars. The stanchion 1100 may be oriented when installed such that a longer dimension thereof extends upwardly from the base rail 104 and extends to a height greater than a height of a south clamp When installed, the stanchion 1100 is positioned such that the height difference provides a desirable south to north increasing slope for optimum sun exposure of the solar panels 102.

The structure 1104 includes a receiver 1106 that is depicted as a clip for receiving a portion of a trim component or wind deflector. The trim component or wind deflector may additionally be secured through a threaded connector, similar to the position 824.

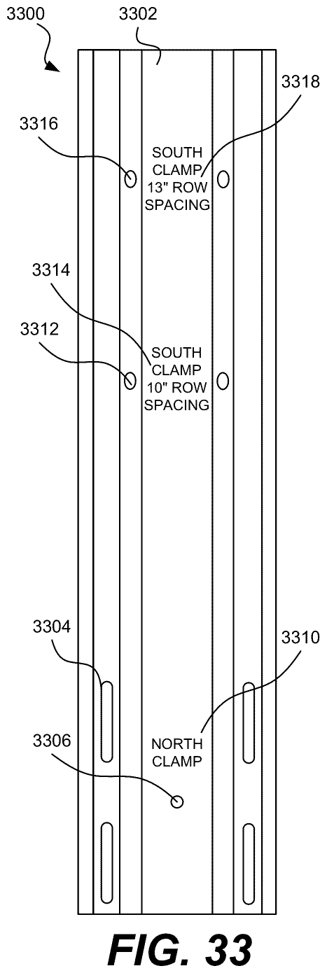

The stanchion 1100 includes a clamp assembly with a support ledge 1108, clamp body 1110, stanchion connector 1112, upper clamp 1114, clamp surface 1116, and threaded connector 1118. The support ledge 1108 may be similar or identical to the support ledge 808, the clamp body 1110 may be similar or identical to the clamp body 810, the stanchion connector 1112 may be similar or identical to the stanchion connector 812, the upper clamp 1114 may be similar or identical to the upper clamp 814, the clamp surface 1116 may be similar or identical to the clamp surface 822, and threaded connector 1118 may be similar or identical to the connector 820. In an embodiment, the connector 1118 may extend through the clamp body 1110 and through an opening in the support ledge 1108 to be secured by a stanchion connector 1112. An embodiment of the stanchion connector 1112 is shown and described with respect to FIG. 33.

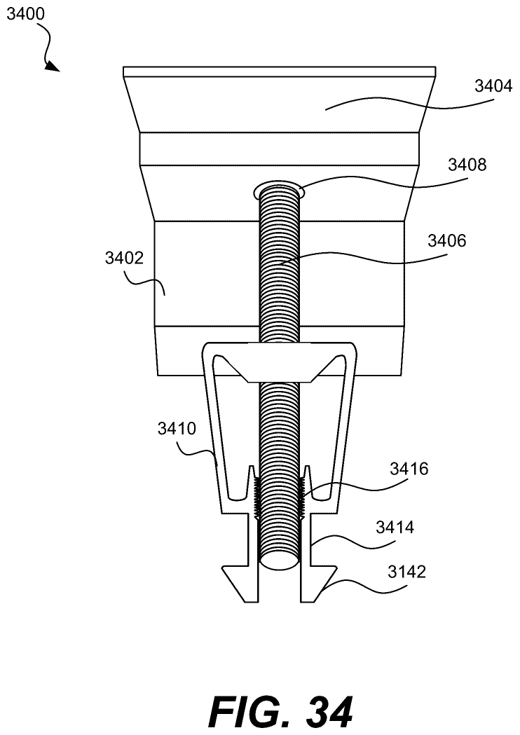

Turning, briefly, to FIG. 34, an assembly 3400 is depicted that includes a portion of a north clamp including an upper clamp 3402, with a clamp surface 3404 that contacts a frame of a solar panel module when the solar panel module is secured into a north clamp. The upper clamp 3402 may be an example of an upper clamp 1114 or other upper clamp assembly as described herein. The upper clamp 3402 defines an opening for a bolt 3406 to pass through. The bolt 3406 may have an O-ring 3408 fitted around the circumference of the bolt 3406 to resist the bolt 3406 moving through the upper clamp 3402. The O-ring 3408 may prevent the upper clamp 3402 from falling or descending during installation, and counteracts gravity to provide an open space between the clamp surface 3404 and a bottom clamp surface of the north clamp. The O-ring 3408 provides resistance that allows the bolt 3406 to be tightened to lower the upper clamp 3402 onto a frame of a solar panel module during installation. In an embodiment, the O-ring 3408 may instead be replaced by a cardboard washer, plastic washer, or other element that impinges on the bolt 3406 to resist movement of the upper clamp 3402 as a result of gravity during installation until the bolt 3406 is tightened. In an embodiment, the hold defined in the upper clamp 3402 may include such impinging features such as teeth, plastic, rubber, paper, cardboard, or other features that may resist movement of the bolt 3406 relative to the upper clamp 3402 while still enabling movement of the bolt 3406 relative to the upper clamp 3402 when the bolt 3406 is tightened.

The bolt 3406 passes through a clamping body 3410 that is used to secure the upper clamp 3402 to a stanchion such as a north stanchion and/or bottom clamp of a north clamp. The clamping body 3410 includes angled surfaces 3412 to guide a tip of the clamping body 3410 into a slotted aperture, such as the slotted aperture 826 shown in FIG. 8. The angled surfaces 3412 may contact the edges of the slotted aperture and cause the clamping body 3410 to deform to fit into the slotted aperture. The clamping body 3410 may have flat sides to fit within the slotted aperture and prevent rotation of the clamping body 3410 once inserted. The clamping body 3410 defines a channel 3414 to capture the edges of the slotted aperture to resist removal of the clamping body 3410 after insertion. A width of the channel 3414 may correspond to a thickness of the material the slotted aperture is formed into.

The clamping body 3410 further includes threads 3416 to interface with the threads of the bolt 3406 to move the upper clamp 3402 relative to the clamping body 3410 as the bolt 3406 is tightened. To assemble the north stanchion and clamp, the clamping body 3410 is inserted into the slotted aperture to capture the edge of the slotted aperture in the channel 3414. Once the clamping body 3410 is inserted into the slotted aperture, the bolt 3406 may be tightened to clamp the upper clamp 3402 against a solar panel module frame.

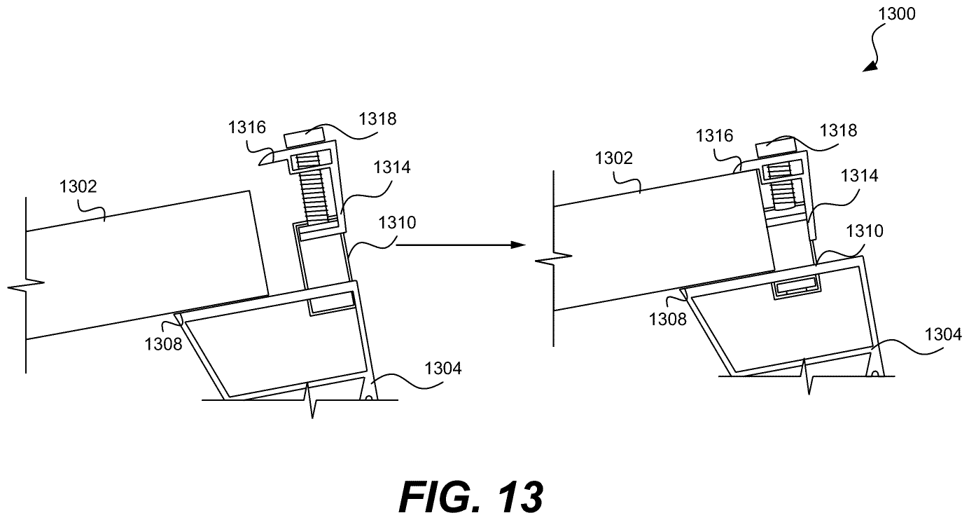

FIG. 13 illustrates detail views of a clamp assembly 1300 with a clamped solar panel 1302, according to an embodiment. The clamp assembly 1300 is shown connected to a north stanchion 1304 (shown only in part) and includes components of the north stanchion 1304 similar or identical to the components of the north stanchion shown and described with respect to FIGS. 8-12. The north stanchion 1304 includes a support ledge 1308, clamp body 1310, upper clamp 1314, upper clamp member 1316, and fastener 1318.

In the detail views shown in FIG. 13, depicting engagement of a solar panel 1302 via a clamp assembly 1300 on a north stanchion. Notably, the north stanchion may provide an easily accessed top-down clamp, preassembled thereon. The unclamped view shows a fastener 1318 and an upper clamp member 1316 of the clamp in a raised position and the clamped view shows the fastener 1318 and upper clamp member 1316 lowered by tightening the fastener 1318 to adjust for the specific thickness of the solar panel 1302 against the upper end of the north stanchion 1304 (shown only in part). The upper clamp member 1316 may be held in position by an O-ring or other feature such as a cardboard washer or feature on a hole of the upper clamp 1314 through which the fastener 1318 extends that impinges on the fastener 1318 to maintain the upper clamp 1314 in the upper position until the fastener 1318 is tightened.

FIGS. 14-15 illustrate an embodiment of a clamp component 1400 for use in a solar panel mounting system 100, according to an embodiment. The clamp component 1400 may be an example of a south clamp as described herein. The clamp component 1400 may be adapted for a flat roof system or other such structure. As depicted, the clamp component 1400 may secure to a rail 1402 such as the base rail 104. The clamp component 1400 includes a lower body 1404 configured with a tab to insert into a slot (not shown) on the rail 1402, as well as with a hole via which a fastener (e.g., bolt or other means) secures the lower body 1404 in place, positioned oppositely from the tab. Additionally, the lower body 1404 may include a panel support ledge 1406 that extends transversely with respect to an upward extension of the lower body 1404 from which the panel support ledge 1406 extends. The panel support ledge 1406 may be shaped non-linearly such that a distal end extends at an angle from a proximal end to facilitate flexion slightly downward to engage the underside of a frame of the solar panel 102. Additionally, an aperture may extend through the panel support ledge 1406 near the proximal end. The aperture may be sized to receive an upper clamp member 1408 therethrough.

The adjacent surfaces of the lower body 1404 and the upper clamp member 1408 may include oppositely engaging teeth 1410 to permit size adjustments for varying thicknesses of different solar panels 102. Once aligned and positioned for a correct thickness of the solar panel 102, the lower body 1404 and the upper clamp member 1408 may be secured in position via a fastener 1414 (e.g., bolt or other means) placed therethrough. In an embodiment, the upper clamp member 1408 may include teeth 1412 on a forward-facing surface that may engage with the aperture of the lower body 1404. The lower body 1404 and the upper clamp member 1408 secure an edge of a solar panel 102 between the panel support ledge 1406 and a clamp member 1416 of the upper clamp member 1408.

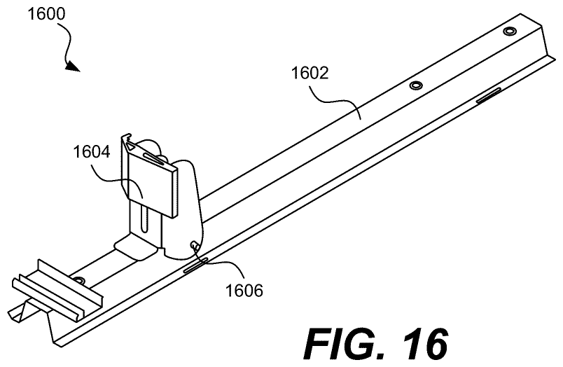

FIG. 16 illustrates a perspective view of a portion of a mounting system 1600 rail 1602 with a south clamp 1604 of the solar panel mounting system, according to an embodiment. The south clamp 1604 is pivotally connected to the rail 1602 through a pin 1606 that enables pivoting rotation of the south clamp 1604 relative to the rail 1602. In some embodiments, the south clamp 1604 may be an example of a clamp as shown and described with respect to U.S. patent application Ser. No. 18/731,886 filed Jun. 3, 2024, and titled “CLAMP FOR SECURING A SOLAR PANEL MODULE,” incorporated by reference herein in its entirety for all purposes.

The south clamp 1604 may include a fastening mechanism, such as a pin 1606, fastener (e.g., bolt), etc. may be disposed through the one or more through holes for securing to the rail 1602. In an embodiment, the south clamp 1604 may be configured to rotate or hinge about the pin 1606. For example, during installation, the south clamp 1604 may be in an upright position relative to the rail 1602. Once the solar panel module 102 is secured to the south clamp 1604, the south clamp 1604 may be rotated to a downward position (e.g., about the X-axis). Between the upright position and the downward position, the south clamp 1604 may rotate about the pin 1606. The south clamp 1604 may therefore be hingedly connected to the rail 1602.

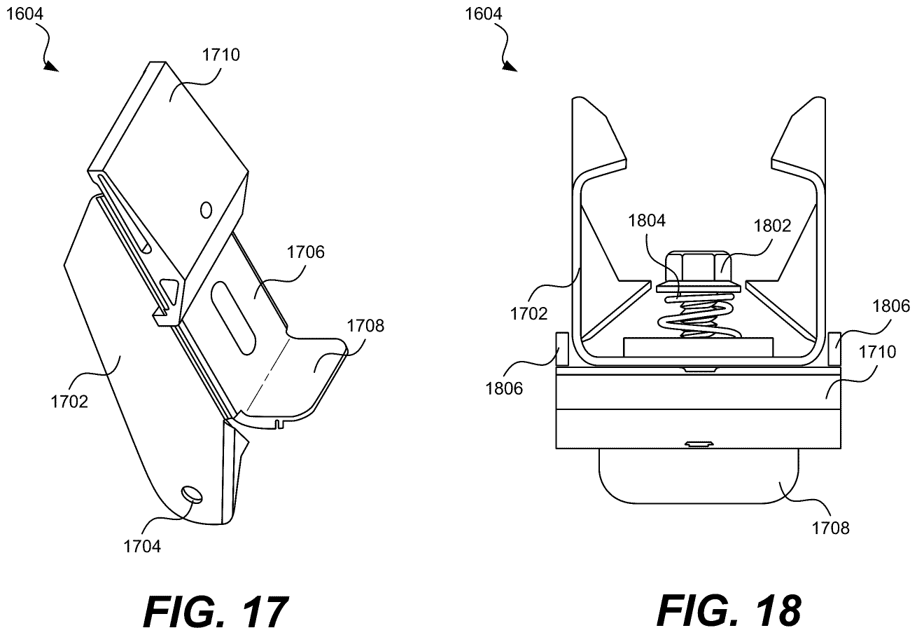

The south clamp 1604, as depicted in FIGS. 17-18 may include a bracket body 1702 sized to ride on and pivotally connect to and through the base rail 104. The south clamp 1604 defines a hole 1704 for securing to the rail 1602 with the pin 1606. The south clamp 1604 includes a base 1706, ledge 1708, and keeper 1710. The base 1706, ledge 1708, and keeper 1710 may be used to secure to an edge of a solar panel 102 and pivot the solar panel downwards until an opposite edge of the solar panel 102 is secured by a north clamp. The keeper 1710 may be pivotably connected with respect to the base 1706 at an upper side of the base 1706. The keeper 1710 may be translatable in a north-south direction enabling the keeper 1710 to fully engage a return flange of a solar module and secure it to the bracket body 1702. The keeper 1710 pivots to hold/keep a flange of the frame of the solar panel 102 against an upper side of the bracket body 1702 when the south clamp 1604 is in an upright position. The south clamp 1604 may connect pivotally (e.g., via a fastener, pin, etc.) to the base rail 104 to secure the solar panel 102 at the south (facing) end thereof in a manner that allows rotation about the pin.

As depicted in FIG. 18, the keeper 1710 may be secured to the bracket body 1702 through a bolt 1802 and a spring 1804. The bolt 1802 and spring 1804 enable the keeper 1710 to be displaced by compressing the spring 1804 and also enables the keeper to rotate relative to the bracket body 1702.

The keeper 1710 includes tabs 1806 that extend over opposite sides of the bracket body 1702. The tabs 1806 contact the bracket body 1702 to maintain alignment of the keeper 1710 with the bracket body 1702. The keeper 1710 may be displaced by compressing the spring 1804 and the keeper 1710 may be rotated one hundred and eighty degrees to a clamping position. The keeper 1710 therefore has a first position as illustrated in FIG. 17 and a second position (not shown) in which the keeper 1710 is rotated one hundred and eighty degrees about the bolt 1802. The tabs 1806 maintain the keeper 1710 in the first position or second position and resists rotation of the keeper 1710 when the fastener 1802 is tightened.

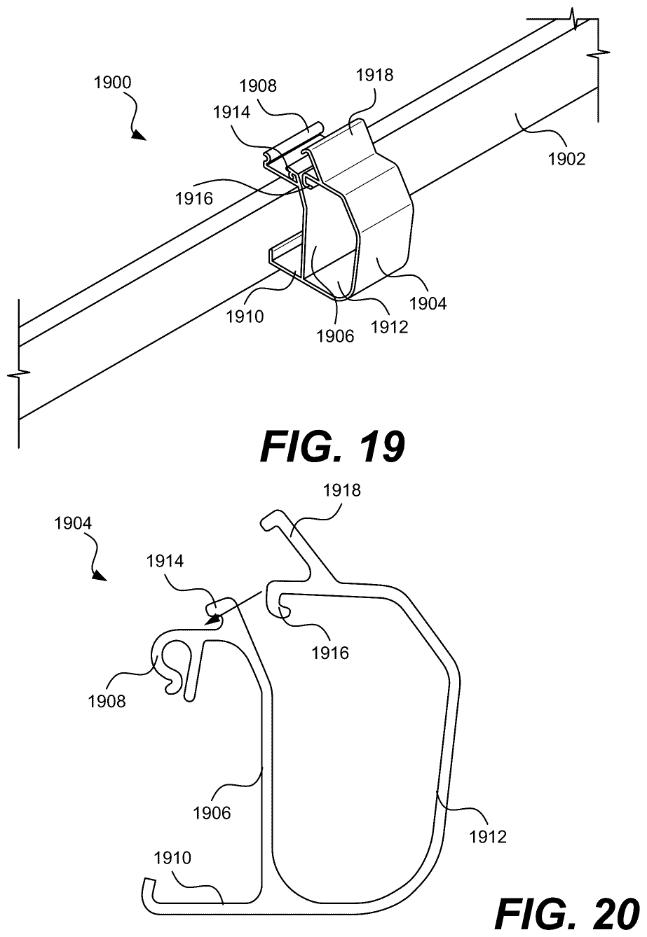

FIG. 19 illustrates a perspective view of a system 1900 including a rail 1902 and wire management clip 1904 of the solar panel mounting system 100, according to an embodiment. The rail 1902 may be an example of the ballast rails 108 or 110 or other rails or components described herein. FIG. 20 illustrates the wire management clip 1904 of FIG. 19 in profile view. The wire management clip 1904 may be formed of a deformable and/or flexible material such as a plastic or other such material.

In an embodiment, the wire management clip 1904 may include a central body portion 1906 having wing extensions extending laterally therefrom. The central body portion 1906 may have a correspondingly shaped U-channeled profile, like that of a ballast rail 108 or 110. The central body portion 1906 having a first wing 1908 and second wing 1910 that extend and fit around or into the ballast rail 108 or 110. As such, the wire management clip 1904 may easily sit on and, in an embodiment, snap onto the ballast rail 108 or 110. The first wing 1908 and the second wing 1910 may fold back toward the central body portion 1906.

The wire management clip 1904 further includes an extension 1912 forming a near enclosed tunnel space such that wiring of the solar panel system may pass therethrough and be maintained in a relatively confined space to assist in wire management. The extension 1912 includes a clip 1916 that engages with a corresponding clip 1914 connected to the central body portion 1906 to secure the extension 1912 and fully enclose the perimeter of the tunnel space. A tab 1918 may provide an interface that a user may interact with to cause the clip 1914 to engage with the clip 1916.

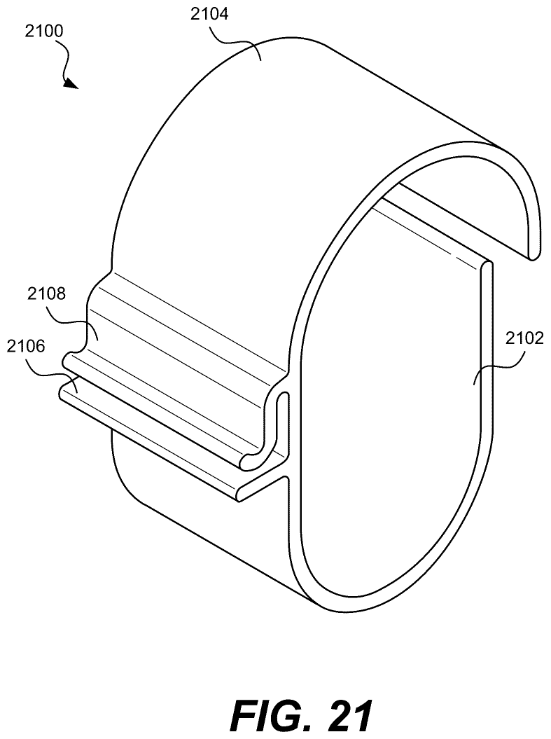

In FIG. 21, an embodiment of a wire management clip 2100 is depicted. The wire management clip 2100 includes an extension 2102 and extension 2104 that form a partially enclosed tunnel space for wire management. The wire management clip 2100 includes a first tab 2106 and a second tab 2108 that may frictionally engage with an edge of a rail or other component of the solar panel mounting system 100 to provide wire management clips 2100 at various locations throughout the solar panel mounting system 100.

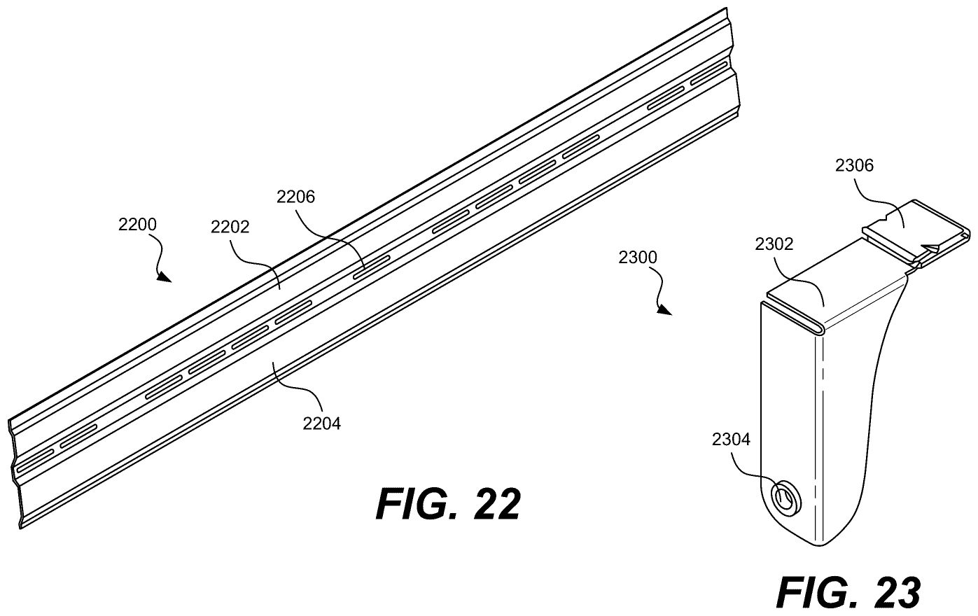

FIG. 22 illustrates a wind deflector 2200 of a solar panel mounting system, according to an embodiment. The wind deflector 2200 may include a metal sheet body 2202 with ridges 2204 and/or openings 2206 formed therein that may enable connection to other components such as stanchions, trim components, or other such components. The wind deflector 2200 may be supported along the length of the wind deflector by connections to the north clamps and/or north stanchions and also to a corner support bracket 2300 depicted in FIG. 23.

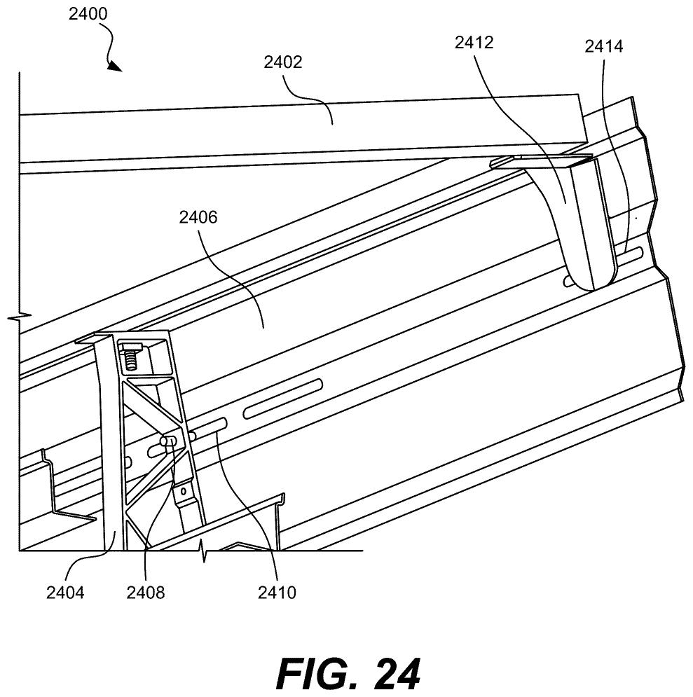

FIG. 23 illustrates a corner support bracket 2300 for a wind deflector 2200 of a solar panel mounting system 100, according to an embodiment. The corner support bracket 2300 includes a body 2302 that forms a ninety-degree angle or L-shaped bracket with an opening 2304 through which a threaded connector may be inserted to secure the wind deflector 2200 to the corner support bracket 2300. The corner support bracket 2300 includes a tab 2306 for connecting to a solar panel frame, such as depicted in FIG. 24.

FIG. 24 illustrates a perspective view of a solar panel mounting system 2400 showing a wind deflector 2406 and corner support bracket 2412, according to an embodiment. The solar panel mounting system 2400 is depicted with a frame 2402 for a solar panel (not showing glass within the frame). The solar panel mounting system 2400 includes a north stanchion 2404 as described herein. The wind deflector 2406 is connected to the north stanchion 2404 through a threaded connector 2408 that passes through openings 2410 of the wind deflector 2406. The corner support bracket 2412 connects to the frame 2402 with the tab shown and described with respect to FIG. 23. The corner support bracket 2412 also connects to the wind deflector 2406 through the opening 2414 and may use a tab, pin, or threaded connector.

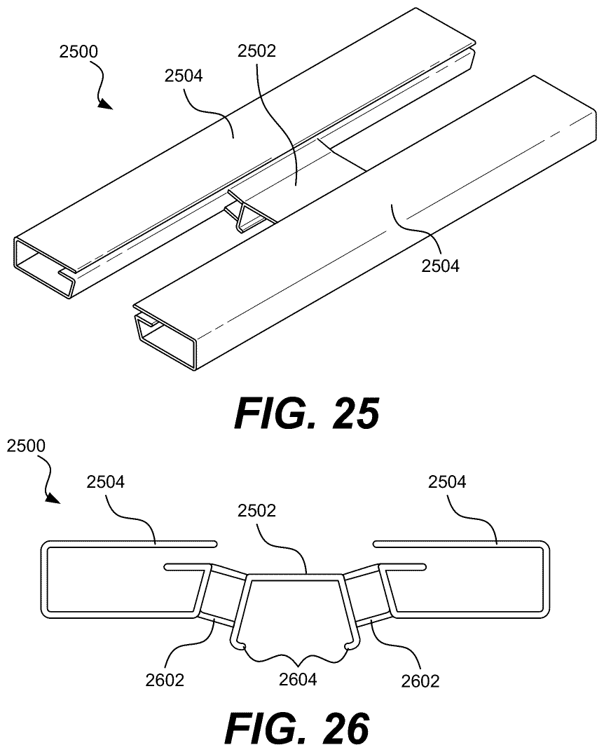

FIGS. 25-26 illustrate a wire management cover 2500 of the solar panel mounting system, according to an embodiment. The wire management cover 2500 includes a central body 2502 that connects to a rail. of FIGS. 19-20. The wire management cover 2500 may snap onto a ballast rail 108 or 110 and provide a first channel 2504 and a second channel 2504 for wire management on opposite sides of the rail. The wire management cover 2500 may be formed of a plastic or other resilient member such that the central body 2502 may deform to snap onto a rail.

As depicted in FIG. 26, the profile of the wire management cover 2500 includes the central body 2502 connected to the first channel 2504 and the second channel 2504 through connections 2602. Additionally, the central body 2502 includes extensions 2604 that deflect and deform to secure to a rail.

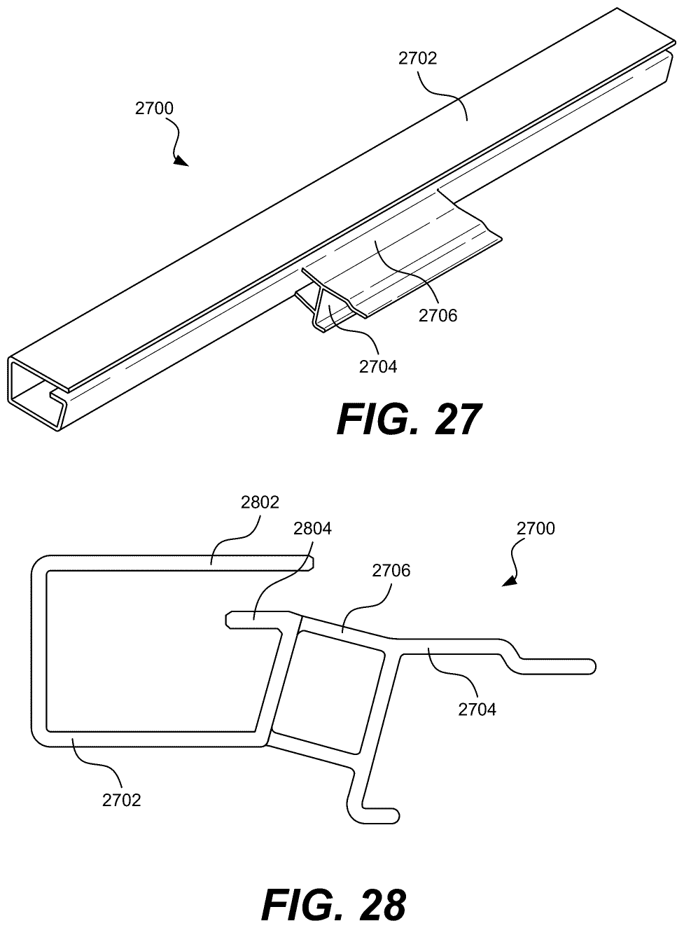

FIGS. 27-28 illustrate a wire management cover 2700 of the solar panel mounting system 100, according to an embodiment. The wire management cover 2700 includes a central body 2704 that connects to a rail, and wire management cover 2500 of FIGS. 25-26. The wire management cover 2700 may snap onto a ballast rail 108 or 110 and provide a channel 2702 for wire management on a side of the rail. The wire management cover 2700 may be formed of a plastic or other resilient member such that the central body 2704 may deform to snap onto a rail. The channel 2702 connects to the central body 2704 through a connector 2706.

As depicted in FIG. 28, the profile of the wire management cover 2700 includes the central body 2704 connected to the channel 2702 through connector 2706. Additionally, the central body 2704 includes extensions that deflect and deform to secure to a rail. The channel 2702 may include an extension 2802 and an extension 2804 that define a semi-enclosed perimeter of the channel 2702 to contain the wires of the solar installation.

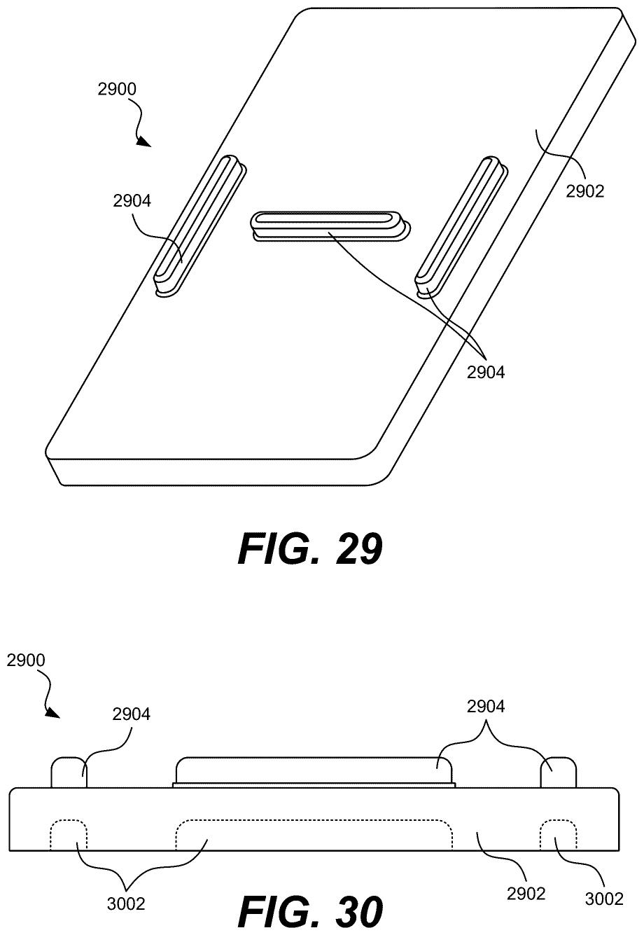

FIGS. 29-30 illustrate a surface mounting pad 2900 for a solar panel mounting system, according to an embodiment. The surface mounting pad 2900 may include a body 2902 having a dimensional size corresponding to at least a dimension of the base rail 104, and further may include protrusions 2904 on an upper surface thereof to interface with the underside of the base rail 104. As such, when installed, the surface mounting pad 2900 may minimize, if not eliminate, contact between the base rail 104 and the surface (e.g., roof) of the location on which the solar panel mounting system 100 is mounted. In an embodiment, the surface mounting pad 2900 may be formed of an elastomeric or plastic product which facilitates greater friction on a roof surface.

In an embodiment, the body 2902 may define cavities 3002 configured to receive protrusions 2904 from an adjacent surface mounting pad 2900 when stacked together. In this manner, the protrusions 2904 and cavities 3002 interlock to maintain the surface mounting pad 2900 stacked and aligned.

FIG. 31 illustrates a view of a portion of a base rail 3100 including markings showing spacing for configuring base rail components based on widths of solar panel modules, according to an embodiment. The base rail 3100 may be an example of the base rail 104. The base rail 3100 has middle portion 3102 that extends along a length of the base rail 3100 and provides a flat surface for markings. The base rail 3100 also includes openings 3104 for receiving mounting components such as protrusions of a roof pad described with respect to FIGS. 29-30.

The middle portion 3102 includes first markings 3106 and second markings 3108. The first markings 3106 and the second markings 3108 may be used by an installer to position components of a base rail 104, for example for positioning a north rail 104A, mid rail 140B, and south rail 104C as shown and described with respect to FIGS. 1-3. The markings 3106 may include an indication of a first solar panel module size as well as measurements and markings for positioning the base rail 3100 relative to other rail components such as north clamps, south clamps, and other rail components, for example as shown and described with respect to FIG. 33. The markings 3108 include similar indications for a second solar panel module size.

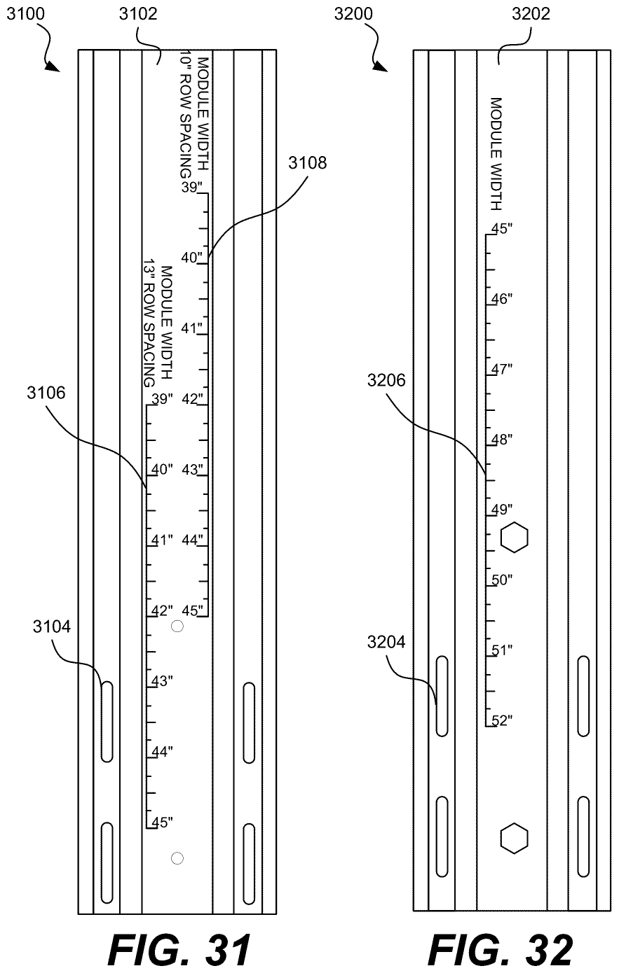

FIG. 32 illustrates a view of a portion of a base rail 3200 including markings showing spacing recommendations and measurements for configuring base rail components based on a width of solar panel modules, according to an embodiment. The base rail 3200 includes a middle portion 3202 similar to the middle portion 3102 that provides a substantially flat surface on which markings 3206 may be placed. The base rail 3200 also includes openings 3204 similar to openings 3104. The markings 3206, and other markings, such as markings 3106 and markings 3108 may be laser engraved, etched, painted, or otherwise affixed or added to the middle portion 3202. The markings 3206 may be used for positioning of mounting system components.

The markings 3106, 3108, and 3206 may be used to assemble an entire north-south length rail, such as a base rail 104 that includes the north rail 104A, mid rail 104B, and south rail 104C. Accordingly, the north rail, 104A, mid rail 104B, and/or south rail 104C may include markings 3106, 3108, and/or 3206. The markings 2106, 3108, and 3206 provide a visual indication of how far each rail segment overlaps an adjacent rail segment. An installer may reference the markings 3106, 3108, and 3206 to determine the correct location and placement of the rail segments without requiring a separate measurement using a tape measure or other additional measuring device.

FIG. 33 illustrates a view of a portion of a base rail 3300 including marking showing locations and indices for guiding assembly of clamp components to the base rail 3300, according to an embodiment. The base rail 3300 includes a middle portion 3302 similar to the middle portion 3102 and middle portion 3202. The base rail 3300 further includes openings 3304 that may be used for mounting the base rail 3300 to a roof pad. The base rail 3300 also includes opening 3306 for receiving a threaded connector and/or base of a north stanchion. A marking 3310 guides an installer to fit the north clamp and north stanchion at the opening.

The base rail further includes openings 3312 and 3316 for receiving a pin to secure a south clamp, such as the south clamp depicted in FIGS. 16-18. The openings 3312 and openings 3316 are accompanied by markings 3314 and markings 3318 indicating the location for placing the south clamp based on the row spacing of the solar panel modules used in the installation (depicted referring to a 10″ row spacing and a 13″ spacing though other spacings are contemplated). The installer may refer to the markings to identify where the south clamp is to be installed during the install process.

Although several embodiments have been described in language specific to structural features and/or methodological acts, it is to be understood that the claims are not necessarily limited to the specific features or acts described. Rather, the specific features and acts are disclosed as illustrative forms of implementing the claimed subject matter.

What is claimed is:

1. A solar panel mounting system comprising:
a base rail;
a north stanchion including:
a first vertical support connected at a first end to the base rail and having a first height;
a first clamp at a second end of the first vertical support, the first clamp configured to secure a first edge of the solar panel;
a south clamp connected at a first end to the base rail and having a second height, the first height greater than the second height, the second clamp configured to secure a second edge of a solar panel at a second end of the south clamp; and
a ballast rail arranged perpendicularly to and connected with the base rail, the ballast rail configured to support one or more ballasts.

2. The solar panel mounting system of claim 1, further comprising:
a wind deflector including a metal panel securable to the north stanchion; and
a corner backet configured to connect between the first edge of the solar panel and the wind deflector.

3. The solar panel mounting system of claim 1, wherein the south clamp includes:
a bottom component including:
a first support surface; and
a first plurality of horizontal protrusions arranged on a vertical portion of the bottom component;
a top component including:
a second support surface; and
a second plurality of horizontal protrusions arranged on a vertical portion of the top component, the second plurality of horizontal protrusions and first plurality of horizontal protrusions configured to interface together to adjust a vertical position of the top component relative to the bottom component; and
a threaded connector through the top component and into the bottom component.

4. The solar panel mounting system of claim 1, wherein:
a vertical portion of the south clamp comprises a first plurality of horizontal protrusions; and
the south clamp includes:
a horizontal portion extending from the vertical portion; and
an upper portion including a second plurality of horizontal protrusions, the upper portion positionable with respect to the vertical portion.

5. The solar panel mounting system of claim 1, further comprising a roof pad formed of an elastomeric material that rests against the base rail and a structure, wherein the roof pad includes a rectangular body and one or more protrusions extending from an upper surface of the rectangular body, the one or more protrusions configured to fit within one or more openings of the base rail.

6. The solar panel mounting system of claim 1, wherein the ballast rail is a first ballast rail and the solar panel mounting system further comprises:
a second ballast rail arranged parallel to the first ballast rail; and
a ballast rail support including a metal component having a first clip that connects with the first ballast rail and a second clip that connects with the second ballast rail.

7. The solar panel mounting system of claim 1, wherein the base rail comprises an angled end forming the first vertical support.

8. The solar panel mounting system of claim 1, further comprising a wire management cover including:
a rail connection component configured to connect with the ballast rail; and
a wire clamp comprising a channel and a tab configured to enclose a passage for receiving one or more wires of a solar panel installation.

9. A modular system for mounting one or more panels to a structure,
a first base rail;
a second base rail arranged in parallel with the first base rail;
one or more north stanchions, wherein a north stanchion of the one or more north stanchions includes:
a first vertical support connected to one of the first base rail or the second base rail and having a first height; and
a first clamp at a second end of the first vertical support, the first clamp configured to secure a first edge of a solar panel;
one or more south clamps, wherein a south clamp of the one or more south clamps includes:
a second vertical portion connected to one of the first base rail or the second base rail and having a second height less than the first height; and
a second clamp at a second end of the second vertical portion, the second clamp configured to secure a second edge of the solar panel; and
a ballast rail arranged perpendicularly to and connected between the first base rail and the second base rail, the ballast rail configured to support one or more ballasts.

10. The modular system of claim 9, wherein the south clamp comprises:
a bottom component including:
a first support surface; and
a first plurality of horizontal protrusions arranged on a vertical portion of the bottom component;
a top component including:
a second support surface; and
a second plurality of horizontal protrusions arranged on a vertical portion of the top component, the second plurality of horizontal protrusions and first plurality of horizontal protrusions configured to interface together to adjust a vertical position of the top component relative to the bottom component; and
a threaded connector through the top component and into the bottom component.

11. The modular system of claim 9, wherein the south clamp includes a pivotal connection between the second vertical portion and the one of the first base rail or the second base rail, and the south clamp includes:
a mount including:
a base defining a slot and a channel,
a first flange extending from the base, and
a second flange extending from the base;
a connector that transitions between a first position in which the solar panel is insertable onto the mount, and a second position in which the solar panel is clamped to the mount, the connector including a pin disposed at least partially through the channel; and
a fastener disposed at least partially through the slot to attach the connector to the mount.

12. The modular system of claim 9, wherein:
the second vertical portion of the south clamps includes a support ledge and a first plurality of interface protrusions arranged along a height of the first vertical support; and
the south clamp further includes:
a third vertical portion including a second plurality of interface protrusions; and
a clamp ledge extending from the third vertical portion, wherein the south clamp is releasably secured to the first vertical portion through a threaded connector.

13. The modular system of claim 9, further comprising a wire management cover including:
a rail connection component configured to connect with a ballast rail; and
a wire clamp comprising a channel and a tab configured to enclose a passage for receiving one or more wires of a solar panel installation.

14. The modular system of claim 9, further comprising one or more roof pads formed of an elastomeric material that rest between the first base rail or the second base rail and a structure wherein a roof pad of the one or more roof pads includes a rectangular body and one or more protrusions extending from an upper surface of the rectangular body, the one or more protrusions configured to fit within one or more openings of the first base rail or the second base rail.

15. The modular system of claim 14, wherein the rectangular body further defines one or more cavities configured to receive the one or more protrusions of an adjacent roof pad when stacked together.

16. The modular system of claim 9, wherein the first base rail comprises an angled end forming the first vertical support.

17. The modular system of claim 9, further comprising:
a wind deflector including a metal panel securable to the north stanchion; and
a corner backet configured to connect between the first edge of the solar panel and the wind deflector.

18. A modular mounting system, comprising
a first base rail;
a second base rail arranged in parallel with the first base rail;
two north stanchions, wherein a north stanchion of the two north stanchions includes:
a first vertical support connected to one of the first base rail or the second base rail and having a first height;
a first clamp at a second end of the first vertical support, the first clamp configured to secure a first edge of a solar panel;
two south clamps, wherein a south clamp of the two south clamps includes:
a second vertical portion connected to one of the first base rail or the second base rail and having a second height;
a second clamp at a second end of the first vertical portion, the second clamp configured to secure a second edge of the solar panel; and
a ballast rail arranged perpendicularly to and connected between the first base rail and the second base rail, the ballast rail configured to support one or more ballasts.

19. The modular mounting system of claim 18, wherein the ballast rail is a first ballast rail and the modular mounting system further comprises:
a second ballast rail arranged parallel to the first ballast rail; and
a ballast rail support including a metal component having a first clip that connects with the first ballast rail and a second clip that connects with the second ballast rail.

20. The modular mounting system of claim 18, further comprising a wire management cover including:
a rail connection component configured to connect with the ballast rail; and
a wire clamp comprising a channel and a tab configured to enclose a passage for receiving one or more wires of a solar panel installation.
